(19) United States
(12) Patent Application Publication
(10) Pub. No.: US 2013/0225290 A1
(43) Pub. Date: Aug. 29, 2013

(54) WEARABLE PERSONAL MINI CLOUD GAME AND MULTIMEDIA DEVICE

(71) Applicants: Dylan T. X. Zhou, San Gabriel, CA (US); Tiger T. G. Zhou, Tiburon, CA (US); Andrew H. B. Zhou, Tiburon, CA (US)

(72) Inventors: Dylan T. X. Zhou, San Gabriel, CA (US); Tiger T. G. Zhou, Tiburon, CA (US); Andrew H. B. Zhou, Tiburon, CA (US)

(21) Appl. No.: 13/857,308

(22) Filed: Apr. 5, 2013

Related U.S. Application Data
(63) Continuation-in-part of application No. 13/287,279, filed on Nov. 2, 2011.

(51) Int. Cl. A63F 13/12

(52) U.S. Cl. CPC A63F 13/12
USPC 463/31; 463/42

(57) ABSTRACT

Provided is a wearable personal mini cloud game and multimedia device and systems and methods for accessing game and multimedia data using the wearable personal mini cloud game and multimedia device. The wearable personal mini cloud game and multimedia device comprises a processor, a memory unit, a communication circuit, and a housing. The processor is configured to communicate with a game and multimedia server over a network to transfer game and multimedia data according to a user request, and transmit the game and multimedia data to one or more external devices, the game and multimedia data being displayed or reproduced by the one or more external devices. The communication circuit is configured to communicate with the network and the one or more external devices.

### RELATED APPLICATIONS

This application is a Continuation-In-Part of U.S. patent application Ser. No. 13/287,279, filed on Nov. 2, 2011, titled “METHODS AND SYSTEMS TO ADVERTISE AND SELL PRODUCTS OR SERVICES VIA CLOUD GAMING ENVIRONMENTS”, which is incorporated herein by reference in its entirety for all purposes.

### FIELD

This application relates generally to cloud gaming environments and, more specifically, to a wearable personal mini cloud game and multimedia device and systems and methods for cloud gaming and entertainment using the mini cloud game and multimedia device.

### BACKGROUND

With the development and widespread of the Internet, many new forms of entertainment and gaming came to existence. One of them, the cloud-based streaming technology, enabled delivering multimedia content to user devices on demand. Such technology makes the capability of the user device unimportant, as processing is performed by a server of a cloud service. As a part of cloud computing, various entertainment cloud services emerged. One of such services is cloud gaming.

Cloud gaming allows direct and on-demand streaming of games onto a user device. At that, the actual game is stored on the game company's server and is streamed directly to computers accessing the server through the client.

Another developing entertainment technology is video on demand. Video on demand (VOD) systems allow users to select and watch/listen to video or audio content on demand. VOD systems either stream content through a set-top box, a computer, or other device, allowing viewing in real time, or download it to a user device for viewing at any time.

With the increasing mobility of the world, users wish that any system could be used in any environment. Thus, it would be useful to have a portable device enabling using cloud based services and video on demand systems in various environments and on various user devices.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided is a wearable personal mini cloud game and multimedia device and systems and methods for accessing game and multimedia data using the wearable personal mini cloud game and multimedia device. The wearable personal mini cloud game and multimedia device may comprise a processor, a memory unit, a communication circuit, and a housing. The processor may be configured to communicate with a game and multimedia server over a network to transfer game and multimedia data, and transmit, on a user request, the game and multimedia data to one or more external devices. The memory unit may be configured to store game and multimedia data and instructions to perform certain operations. The communication circuit may be configured to communicate with the network and the one or more external devices.

In some embodiments, the device may have a length of approximately 2 inches.

In certain example embodiments, the communication circuit may include a Bluetooth module, a communication port, including a universal serial bus (USB) port, a DisplayPort, a High-Definition Multimedia Interface (HBMI) port, a parallel port, an infrared transceiver port, a radiofrequency transceiver port, and so forth. One or more external devices may include a television set, a set-top box, a computer, a laptop, a smartphone, a wearable personal digital device, a digital eyeglass device, and so forth. Using, for example, a DisplayPort or HBMI port, the device may connect to such external devices as a television set, display, speaker, and so forth to transmit video and/or audio data. In some embodiments, the digital eyeglass device may be used to display the game and multimedia data.

In some embodiment, the communication circuit, for example, USB port, DisplayPort, or HBMI port, may be used to supply power to the device.

In some embodiments, the user may communicate with the wearable personal mini cloud game and multimedia device using a controller. The controller may communicate with the wearable personal mini cloud game and multimedia device via a Bluetooth module, a communication port, including a USB port, a DisplayPort, an HBMI port, a parallel port, an infrared transceiver port, a radiofrequency transceiver port, and so forth.

Provided also a system for accessing game and multimedia data using a wearable personal mini cloud game and multimedia device. In certain embodiments, the system may include the wearable personal mini cloud game and multimedia device described above, a display device, a controller, and a game and multimedia server. The display device may be communicatively coupled to the wearable personal mini cloud game and multimedia device, and configured to receive the game and multimedia data from the wearable personal mini cloud game and multimedia device, and display the game and multimedia data. The game and multimedia data may include cloud game data, video on demand data, network data, and so forth. In various embodiments, the display device may include a digital eyeglass device, a television set, a set-top box, a computer, a laptop, a smartphone, a wearable personal digital device, and so forth. The controller may be communicatively coupled to the wearable personal mini cloud game and multimedia device, and configured to sense a user command and transmit the user command to the wearable personal mini cloud game and multimedia device. The wearable personal mini cloud game and multimedia device may further transfer the user command to the game and multimedia server. The game and multimedia server may be configured to communicate with the wearable personal mini cloud game and multimedia device over a network to transfer the game and multimedia data; receive the command data related to the user command; and process the command data.

In certain embodiments, the communication between components of the system may be performed using a Bluetooth module, a communication port, including a USB port, a DisplayPort, an HBMI port, a parallel port, an infrared transceiver port, a radiofrequency transceiver port, and so forth.

In certain embodiments, the game and multimedia server may be further configured to transfer advertising data related to the game and multimedia data. The advertising data may be displayed by the display device.

Provided also a method for accessing game and multimedia data using a wearable personal mini cloud game and multimedia device. In certain embodiments, the method may comprise receiving, by the wearable personal mini cloud game and multimedia device, a user request to display the game and multimedia data; communicating with a game and multimedia server over a network to transfer game and multimedia data; and displaying the game and multimedia data on a display device. The display device may include a digital eyeglass device, a television set, a set-top box, a computer, a laptop, a smartphone, a wearable personal digital device, and so forth.

In some embodiments, the method may further comprise receiving, from a controller, a user command; transferring the user command to a game and multimedia server; processing the user command; and transferring data related to the processing to the wearable personal mini cloud game and multimedia device.

In some embodiments, communication between the wearable personal mini cloud game and multimedia device and other devices may be performed using one or more of the following: a Bluetooth module, a communication port, including a USB port, a DisplayPort, an HBMI port, a parallel port, an infrared transceiver port, a radiofrequency transceiver port.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 illustrates an example network segment for implementing various aspects of methods and systems for accessing game and multimedia data using the wearable personal mini cloud game and multimedia device.

FIG. 2 is a block diagram showing various elements of the wearable personal mini cloud game and multimedia device, in accordance with certain embodiments.

FIG. 3 illustrates an example system for accessing game and multimedia data using the wearable personal mini cloud game and multimedia device used to view video on demand, in accordance to certain example embodiments.

FIG. 4 illustrates an example system for accessing game and multimedia data using the wearable personal mini cloud game and multimedia device, in accordance to certain example embodiments.

FIG. 5 illustrates an example system for accessing game and multimedia data using the wearable personal mini cloud game and multimedia device connected to a wearable personal digital device and a digital eyeglass device, in accordance to certain example embodiments.

FIG. 6 is a flow chart illustrating a method for accessing game and multimedia data using the wearable personal mini cloud game and multimedia device, in accordance with certain embodiments.

### DETAILED DESCRIPTION

A wearable personal mini cloud game and multimedia device, systems and methods for accessing game and multimedia data using the wearable personal mini cloud game and multimedia device are described herein. The wearable personal mini cloud game and multimedia device may enable a user to play games, view multimedia content, access network (e.g. Internet), and perform other operations in any environment. The device may comprise a processor, a memory, a communication circuit, and a housing. The size of the device may be relatively small. For example, it may be approximately 2 inches long. Such compactness may allow a user to carry the device and employ it when required. For example, when willing to play a game or watch/listen multimedia, a user may connect the device to an external device (e.g. a TV set, a smart phone, a lap top, a digital eyeglass device, a wearable personal digital device). When connected in such a way, the device may communicate with a game and multimedia server over a network and transfer game and multimedia data to/from the game and multimedia server. In some embodiments, the device may communicate with a network to provide the user with access to the network and the game and multimedia server. Thus, the user may play cloud games and/or view video on demand or access other content in any environment.

In some embodiments, to control the device operation and give commands to control a game or multimedia reproduction, the user may apply a controller. The controller may connect wirelessly or by wires to the device and may be configured to sense user commands and transmit the sensed commands to the device.

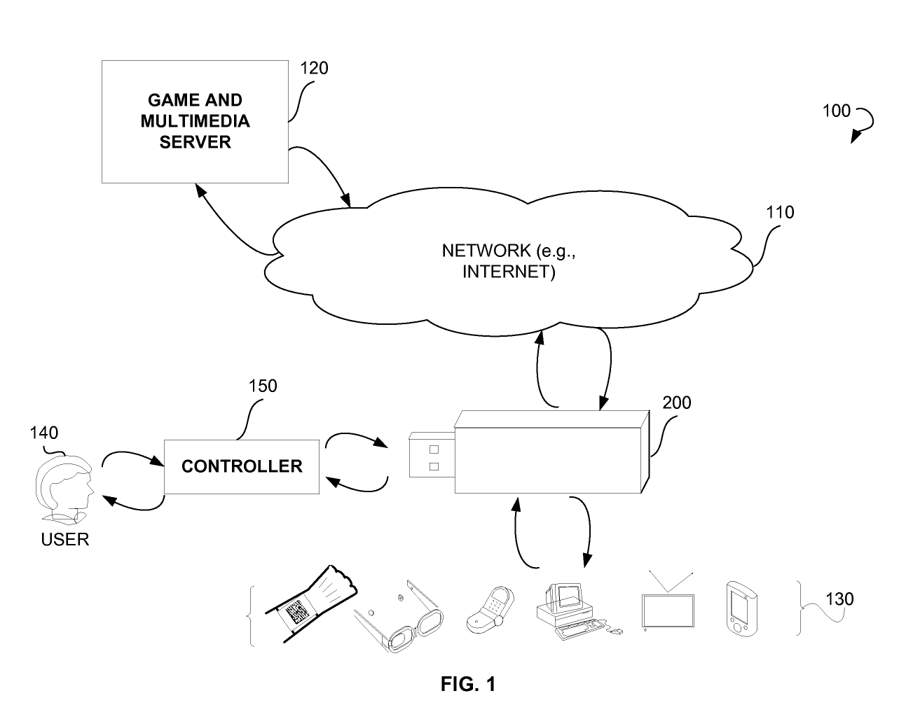

To enable device connection with the one or more external devices and/or controller, the device may have the communication circuit. The communication circuit may include a Bluetooth module, a communication port, including a universal serial bus (USB) port, a DisplayPort, a High-Definition Multimedia Interface (HBMI) port, a parallel port, an infrared transceiver port, a radiofrequency transceiver port, and so forth. The device may have Internet connectivity using cellular networks (e.g., 3G, 4G) as well as Wi-Fi and other types of networks. Some additional examples of such networks are described below with reference to FIG. 1. Wireless communication may be used to transmit and receive the game and multimedia data to/from the game and multimedia server and one or more external devices, transmit user commands, and so forth. Overall, various data may be exchanged between the device and the game and multimedia server as well as other servers during operations of the method.

Before describing various methods and associated operations, a brief description of a computer network. Specifically, FIG. 1 illustrates an example network segment for implementing various aspects of systems and methods for accessing game and multimedia data using the wearable personal mini cloud game and multimedia device. As shown, one or more external devices 130 may communicate with a wearable personal mini cloud game and multimedia device 200. The wearable personal mini cloud game and multimedia device 200 may communicate with a game and multimedia server 120 over a network 110. The network 110 may be also used for communication of among various components of a system for accessing game and multimedia data using the wearable personal mini cloud game and multimedia device. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may include any suitable number and type of devices, e.g., routers and switches, for forwarding commands, content, and/or web object requests from each client to the online community application and responses back to the clients. The device 200 may communicate with the GPS satellite via the network 110 to exchange data on a geographical location of the device 200. Additionally, the device 200 may communicate with mobile network operators using a mobile base station.

The methods described herein may also be practiced in a wide variety of network environments (represented by network 110) including, for example, TCP/IP-based networks, telecommunications networks, wireless networks, etc. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be effected or employed at different locations.

The device 200 may be connected to the one or more external devices 130. The external devices 130 may include a television set, a set-top box, a computer, a laptop, a smart phone, a wearable personal digital device, a digital glass device, and so forth. The device 200 may connect to the one or more external devices 130 wirelessly or by wires using various connections such as a USB port, a DisplayPort, an HBMI port, a parallel port, an infrared transceiver port, a radiofrequency transceiver port, and so forth. For example, the device may connect to a television set, a display, and/or speaker using a USB port, a DisplayPort, or an HBMI port to transmit video and/or audio data.

A user 140 may interface with the device 200 using a controller 150. The controller may include a special-purpose controller, a mouse controller, a key board, a touchscreen, and so forth. The controller 150 may sense user command via one or more control elements and transmit the sense user commands to the device 200. The device may transmit the received user commands to the game and multimedia server 120 over the network 110 and receive response data from the game and multimedia server 120.

In other embodiments, the user may communicate with the device 200 via control elements of the one or more external devices 130, using eye movements sensed by a digital glass device, or otherwise.

For the purposes of communication, the device 200 may be compatible with one or more of the following network standards: GSM, CDMA, LTE, IMS, Universal Mobile Telecommunication System (UMTS), 4G, 5G, 6G and upper, RFID, and so forth.

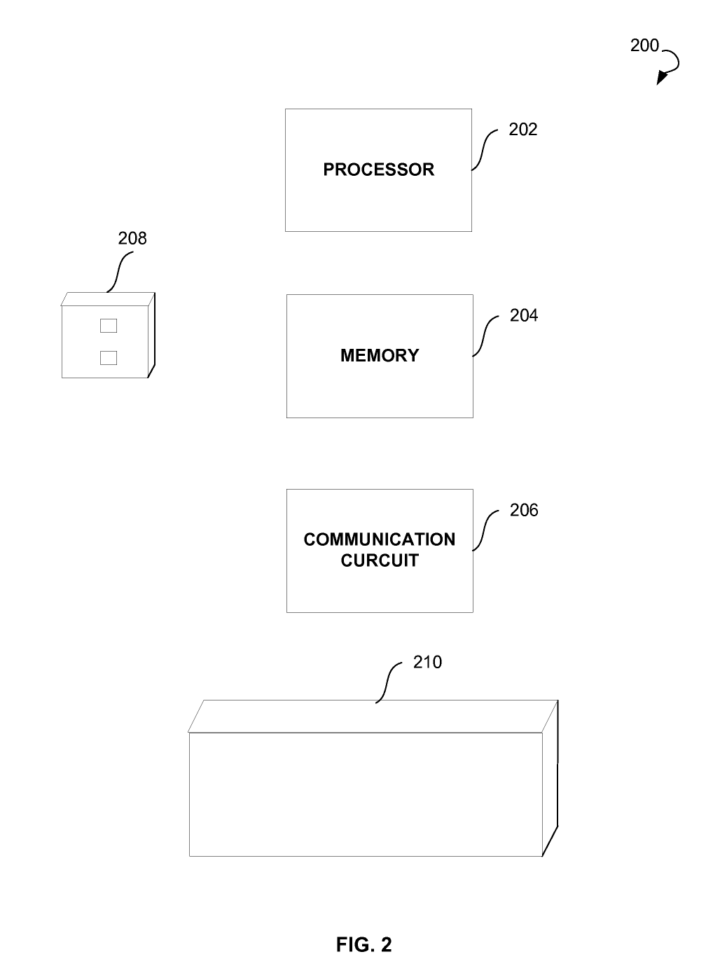

FIG. 2 is a block diagram showing various elements of the wearable personal mini cloud game and multimedia device 200, in accordance with certain embodiments. Specifically, the wearable personal mini cloud game and multimedia device 200 may comprise a processor 202, a memory unit 204, a communication circuit 206, and a housing 210.

The processor 202 may be configured to communicate with a game and multimedia server over a network to transfer game and multimedia data, and to transmit, on a user request, the game and multimedia data to one or more external devices. The processor 202 may include various types including microcontrollers and microprocessors such as programmable devices (e.g., CPLDs and FPGAs) and unprogrammable devices such as gate array ASICs or general purpose microprocessors.

The memory unit 204, such as tangible computer readable memory, may store the game and multimedia data and/or instructions to perform one or more operations. In some embodiments, the memory unit 204 may be used as a mobile storage or cloud storage. Data to the mobile or cloud storage may be transmitted and/or synchronized, for example, using a USB port or another port, or wirelessly over network.

The communication circuit 206 may be communicatively coupled to the processor 202 and configured to communicate with the network and one or more external devices. In various embodiments, the communication circuit may include a Bluetooth module, a communication port, including a USB port, a DisplayPort, an HBMI port, a parallel port, an infrared transceiver port, a radiofrequency transceiver port, and so forth. The housing 210 may enclose the processor 202, the memory unit 206, and the communication circuit 208.

In some embodiments, the wearable personal mini cloud game and multimedia device 200 may comprise a USB port 208. The USB port 208 may be used to connect the device 200 to an external device.

In some example embodiments, the device 200 may have a length of approximately 2 inches.

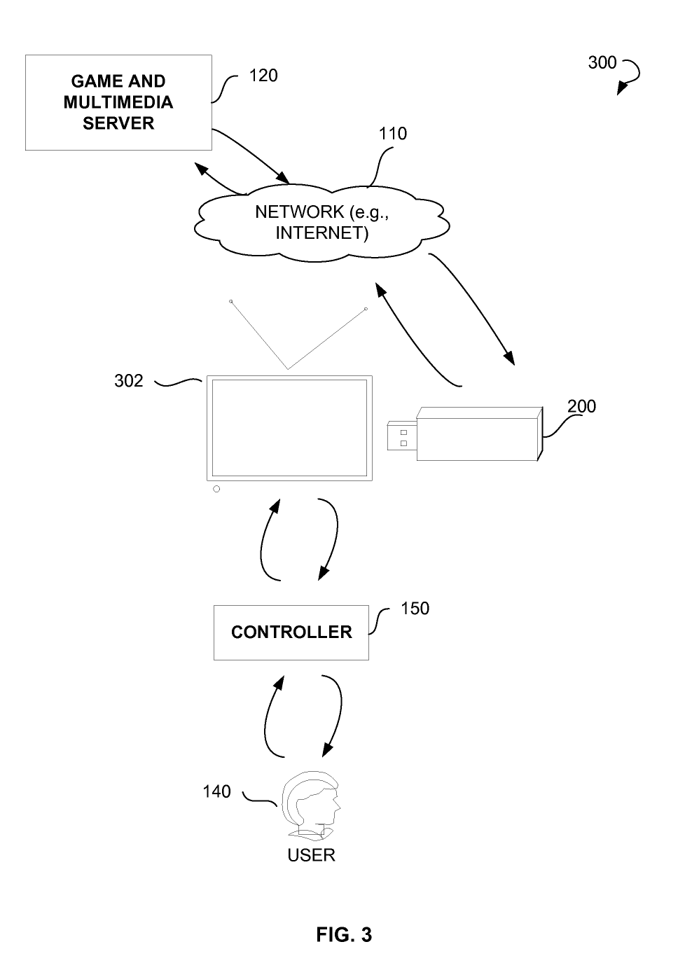

FIG. 3 illustrates an example system 300 for accessing game and multimedia data using the wearable personal mini cloud game and multimedia device used to view video on demand, in accordance to certain example embodiments. The system 300 includes a network 110, such as the network described with reference to FIG. 1, a game and multimedia server 120, a wearable personal mini cloud game and multimedia device 200, a TV set 302, a controller 150, and a user 140. The device 200 may be connected to the TV set 302 using a USB port, a DisplayPort, an HDMI port, or the like. The device 200 may communicate with the game and multimedia server 120 over the network 110 to transfer game and multimedia data on demand of the user 140. The user 140 may apply the controller 150 to give commands to the device 200. The commands may be transmitted by the device 200 to the game and multimedia server 120. Based on the commands, the game and multimedia server 120 may modify or provide the game and multimedia data. For example, the user 140, using the controller 150, may give commands related to the content the user 140 wishes to view. The commands may be transmitted to the device 200 and further to the game and multimedia server 120. The game and multimedia server 120 may process the received commands and transfer the game and multimedia data according to the processed commands to the device 200. The device 200 may then cause the TV set 302 to display and/or reproduce the game and multimedia data received from the game and multimedia server 120. Thus, the user 140 may access video on demand on any suitable device.

In some embodiments, the game and multimedia data to be transferred by the game and multimedia server 120 to the device 200 may be rendered and/or compressed by the game and multimedia server 120 and transmitted over the network in a low bit rate.

In some embodiments, user behavior in relation to the game and multimedia data may be analyzed. Based on the analysis, advertising data may be displayed to the user. For example, when the analysis reveals that the user requests movies of a specific genre, advertising data associated with the movies of this genre may be displayed to the user.

Additionally, in further embodiments, the device 200 may serve as a burglar alarm device. The device 200, connected to a display device, such as a TV set, and not used by the user, may detect intrusion and activate an alarm, for example, a sound alarm, a light alarm, and so forth. Moreover, on intrusion detection, the device 200 may start recording audio. For audio recording the device 200 in some embodiments may include a built-in microphone.

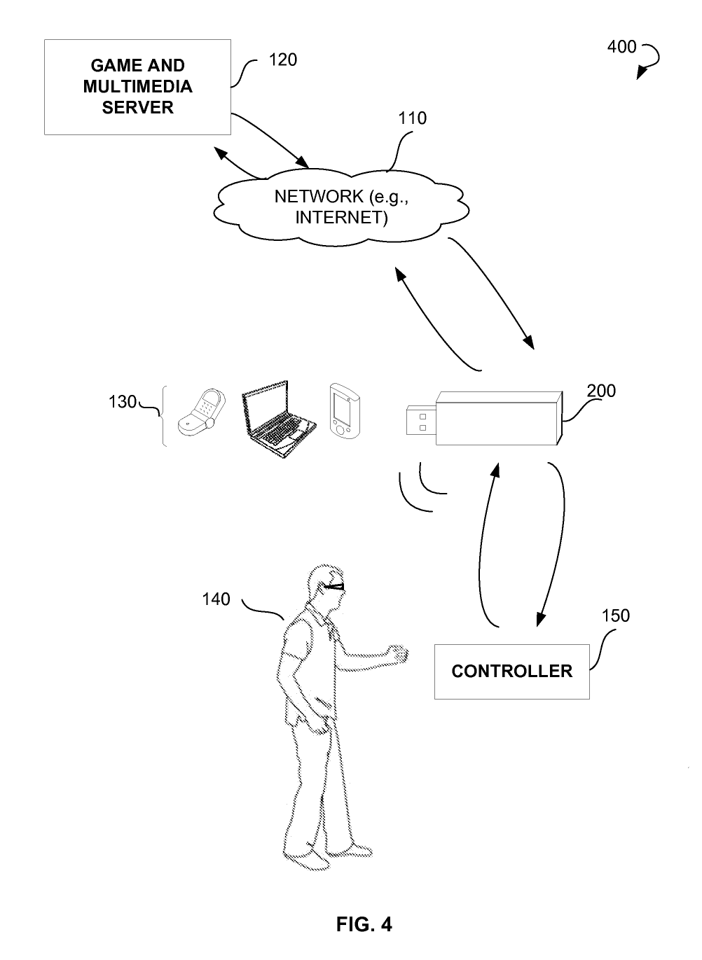

FIG. 4 illustrates an example system 400 for accessing game and multimedia data using the wearable personal mini cloud game and multimedia device, in accordance to certain example embodiments. The system 400 includes a network 110, such as the network described with reference to FIG. 1, a game and multimedia server 120, a wearable personal mini cloud game and multimedia device 200, an external device 130, a controller 150, and a user 140. The device 200 may be connected to the external device 130 using a USB port. The external device, in this example embodiment, may include a smart phone, a lap top, a tablet PC, and so forth. The device 200 may communicate with the game and multimedia server 120 over the network 110 to transfer game and multimedia data on demand of the user 140. To communicate with the device 200 and give commands related to the desired content, the user 140 may apply control elements of the external device 130 or the controller 150. In various embodiments, the controller 150 may include a special-purpose controller, a mouse controller, a keyboard, a touchscreen, and so forth. The commands sensed by the controller 150 may be transmitted by the device 200 to the game and multimedia server 120. Based on the commands, the game and multimedia server 120 may provide or modify the game and multimedia data. For example, the user 140, using the controller 150, may give commands in the process of a cloud game provided by the game and multimedia server 120 on demand of the user 140. Thus, the user 140 may play a cloud game using the device 200 in any environment and using any suitable device.

In some embodiments, the user 140 may pay a monthly fee to access the gaming and multimedia data on the game and multimedia server 120. In addition to that gamer ratings may be calculated and the gamers with higher ratings may receive a reward. For example, the gamer with the highest rating of a month in a specific game may receive a present, a money reward, an unlimited access to the gaming and multimedia data on the game and multimedia server 120 for a specific period, and so forth.

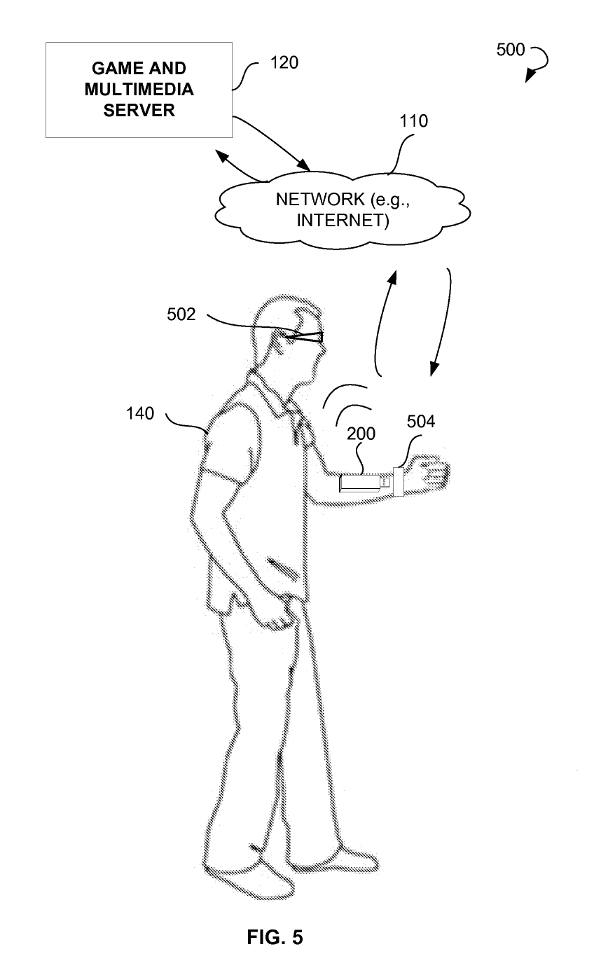

FIG. 5 illustrates an example system 500 for accessing game and multimedia data using the wearable personal mini cloud game and multimedia device connected to a wearable personal digital device and a digital eyeglass device, in accordance to certain example embodiments. The system 500 may include a network 110, such as the network described with reference to FIG. 1, a game and multimedia server 120, a wearable personal mini cloud game and multimedia device 200, a digital eyeglass device 502, a wearable personal digital device 504, and a user 140. The device 200 may be connected to the wearable personal digital device 504 using a USB port. The device 200 may be connected to the wearable personal digital device 504 and communicate with the game and multimedia server 120 over the network 110 to transfer game and multimedia data on demand of the user 140. The wearable personal digital device 504 may wirelessly communicate with the digital eyeglass device 502 to display the game and multimedia data received from the device 200. To communicate with the device 200 and give commands related to the desired content, the user 140 may apply control elements of the wearable personal digital device 504. Such control elements may include one or more buttons, one or more scrollers, a touch screen, and so forth. In some example embodiments, the user 140 may give commands via the digital eyeglass device 502, for example, by eye movements, glance direction, winks, and so forth. Thus, the user 140 may play a cloud game, view video on demand, access network resources, and so forth using the device 200 connected to the wearable personal digital device 504 and the digital eyeglass device 502. This allows the user 140 to play games and/or view multimedia content in any environment, even on the go.

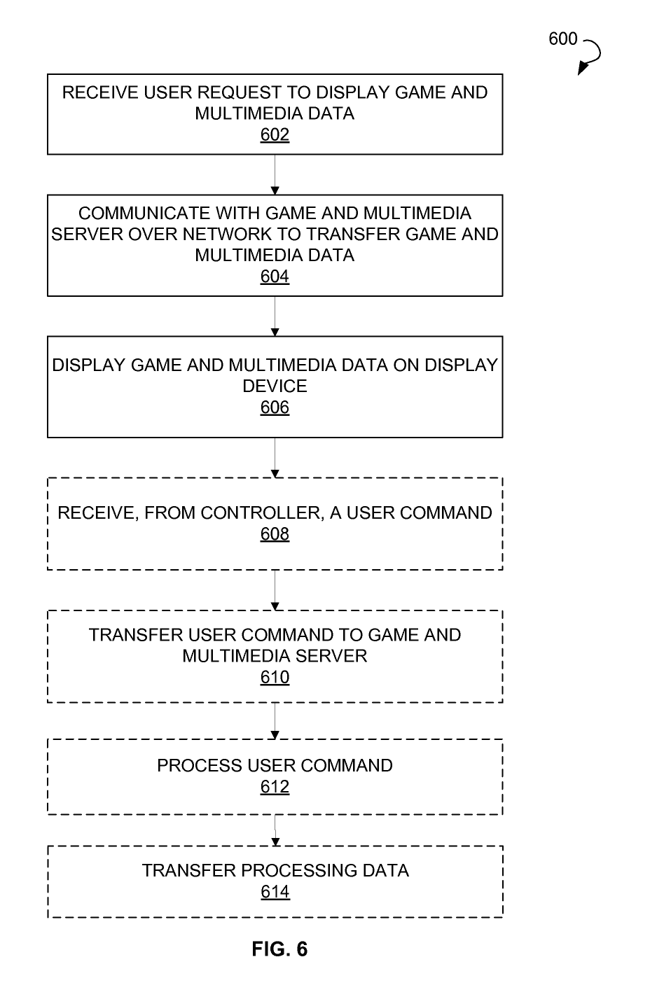

FIG. 6 is a flow chart illustrating a method 600 for accessing game and multimedia data using the wearable personal mini cloud game and multimedia device, in accordance with certain embodiments. Method 600 may start with a game and multimedia server receiving a user request to display game and multimedia data at operation 602. The user request may be received from the wearable personal mini cloud game and multimedia device. At operation 604, the wearable personal mini cloud game and multimedia device may communicate with the game and multimedia server over network to transfer the game and multimedia data based on the user request. For example, a user may request to play a game, view a movie, and so forth. The transferred game and multimedia data may be displayed on a display device at operation 606. In various embodiments, the display device may include a digital eyeglass device, a television set, a set-top box, a computer, a laptop, a smartphone, a wearable personal digital device, and so forth. Operation 602 may also involve displaying advertising data related to the game and multimedia data. The advertising data may be provided and transferred by the game and multimedia server to the wearable personal mini cloud game and multimedia device to be displayed in pauses between the game and multimedia data, overlapping the game and multimedia data, or otherwise.

In some embodiments, the user may apply a controller to communicate with the wearable personal mini cloud game and multimedia device. For example, the user may use it to give commands during a game or when watching video. Method 600 may optionally proceed with receiving, from a controller, a user command at operation 608. The command may be sensed by the controller and transmitted to the wearable personal mini cloud game and multimedia device by the controller wirelessly or by wires.

At optional operation 610, the user command may be transferred to the game and multimedia server. The game and multimedia server may process the received user command at optional operation 612, and transfer the processing data to the wearable personal mini cloud game and multimedia device at optional operation 614.

In certain embodiments, the network for communicating of the wearable personal mini cloud game and multimedia device with external devices may include GSM, CDMA, LTE, IMS, Universal Mobile Telecommunication System (UMTS), RFID, WiFi, 4G, 5G, 6G and upper.

Thus, various systems and methods for accessing game and multimedia data using the wearable personal mini cloud game and multimedia device have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A wearable personal mini cloud game and multimedia device, the device comprising:
a processor configured to:
communicate with a game and multimedia server over a network to transfer game and multimedia data;
transfer, on a user request, the game and multimedia data to one or more external devices;
a memory unit communicatively coupled to the processor;
a communication circuit communicatively coupled to the processor and configured to communicate with the network and the one or more external devices; and
a housing adapted to enclose the processor, the memory unit, and the communication circuit.

2. The device of claim 1, wherein the communication circuit includes one or more of the following: a Bluetooth module, a communication port, including a universal serial bus (USB) port, a DisplayPort, a High-Definition Multimedia Interface (HBMI) port, a parallel port, an infrared transceiver port, and a radiofrequency transceiver port.

3. The device of claim 1, wherein the one or more external devices include a television set, a set-top box, a computer, a laptop, a smartphone, a wearable personal digital device.

4. The device of claim 1, wherein the one or more external devices include a digital eyeglass device.

5. The device of claim 4, wherein the game and multimedia data are displayed by the digital eyeglass device.

6. The device of claim 1, wherein a user communicates with the wearable personal mini cloud game and multimedia device using a controller.

7. The device of claim 6, wherein the device connects to the controller via one or more of the following: a Bluetooth module, a communication port, including a universal serial bus (USB) port, a parallel port, an infrared transceiver port, a radiofrequency transceiver port.

8. The device of claim 1, wherein the device has a length of approximately 2 inches.

9. The device of claim 1, wherein the device is compatible with one or more of the following network standards: GSM, CDMA, LTE, IMS, Universal Mobile Telecommunication System (UMTS), RFID, WiFi, 4G, 5G, 6G and upper.

10. The device of claim 1, wherein the communication circuit is used to supply power to the wearable personal mini cloud game and multimedia device.

11. The device of claim 1, wherein the memory unit stores data transmitted to the device using a USB port on a user command.

12. The device of claim 1, wherein the memory unit synchronizes, using a USB port or a local network, cloud data stored in the memory unit.

13. The device of claim 1, further comprising a microphone configured to receive audio signals and record one or more audio records.

14. A system for accessing game and multimedia data using a wearable personal mini cloud game and multimedia device, the wearable personal mini cloud game and multimedia device comprising the wearable personal mini cloud game and multimedia device of claim 1, and the system comprising:
a display device communicatively coupled to the wearable personal mini cloud game and multimedia device, and configured to:
receive the game and multimedia data from the wearable personal mini cloud game and multimedia device; and
display the game and multimedia data;
a controller communicatively coupled to the wearable personal mini cloud game and multimedia device, and configured to:
sense a user command; and
transmit the user command to the wearable personal mini cloud game and multimedia device, the wearable personal mini cloud game and multimedia device transferring the user command to a game and multimedia server;
the game and multimedia server configured to:
communicate with the wearable personal mini cloud game and multimedia device over a network to transfer the game and multimedia data;
receive the user command; and
process the user command.

15. The system of claim 14, wherein communication between components of the system is performed using a Bluetooth module, a communication port, including a universal serial bus (USB) port, a DisplayPort, a High-Definition Multimedia Interface (HBMI) port, a parallel port, an infrared transceiver port, a radiofrequency transceiver port.

16. The system of claim 14, wherein the display device includes a digital eyeglass device, a television set, a set-top box, a computer, a laptop, a smartphone, and a wearable personal digital device.

17. The system of claim 14, wherein the wearable personal mini cloud game and multimedia device further communicates with a network server to access network.

18. The system of claim 14, wherein the game and multimedia server is further configured to transfer advertising data related to the game and multimedia data, the advertising data displayed by the display device.

19. The system of claim 14, wherein the game and multimedia data include cloud gaming data, video on demand data, and network data.

20. A method for accessing game and multimedia data using a wearable personal mini cloud game and multimedia device, the wearable personal mini cloud game and multimedia device comprising the wearable personal mini cloud game and multimedia device of claim 1, and the method comprising:
receiving, for a user, a user request to display the game and multimedia data;
communicating with a game and multimedia server over a network to transfer game and multimedia data; and
displaying the game and multimedia data on a display device.

21. The method of claim 20, further comprising:
receiving, from a controller, a user command;
transferring the user command to the game and multimedia server;
processing, by the game and multimedia server, the user command; and
transferring data related to the processing to the wearable personal mini cloud game and multimedia device.

22. The method of claim 20, further comprising:
analyzing the user request and the displayed game and multimedia data; and
displaying, based on the analysis, advertizing data on the display device.

23. The method of claim 20, wherein the communication is performed using one or more of the following: a Bluetooth module, a communication port, including a universal serial bus (USB) port, a DisplayPort, a High-Definition Multimedia Interface (HBMI) port, a parallel port, an infrared transceiver port, a radiofrequency transceiver port.

24. The method of claim 20, wherein the display device includes a digital eyeglass device, a television set, a set-top box, a computer, a laptop, a smartphone, and a wearable personal digital device.

25. The method of claim 20, wherein the network includes one or more of the following: GSM, CDMA, LTE, IMS, Universal Mobile Telecommunication System (UMTS), RFID, 4G, 5G, 6G and upper.

26. The method of claim 20, wherein the game and multimedia data to be transferred to the wearable personal mini cloud game and multimedia device are processed by the game and multimedia server to lower a bitrate of the game and multimedia data.

27. The method of claim 26, wherein the processing includes rendering and compressing.

28. The method of claim 20, further comprising:
connecting the device to the display device, the display device including a television set;
detecting intrusion using capabilities of the display device;
activating, based on the detection, an intrusion alarm, the intrusion alarm including a sound alarm and a light alarm; and
optionally recording an audio record using a microphone of the device.

29. The method of claim 20, wherein the user pays a fee to gain access to the game and multimedia data on the game and multimedia server.
